(19) United States
(12) Patent Application Publication
(10) Pub. No.: US 2015/0130841 A1
(43) Pub. Date: May 14, 2015

(54) METHODS AND COMPUTING DEVICES TO MEASURE MUSCULOSKELETAL MOVEMENT DEFICIENCIES

(71) Applicant: MEDICAL COMPANION LLC, Milwaukee, WI (US)

(72) Inventors: Navjot Kohli, River Hills, WI (US); Jivtesh Singh, Padstow (AU); Christopher Rogers, Oconomowoc, WI (US); Miroslav Smukov, Novi Sad (RS)

(21) Appl. No.: 14/602,200

(22) Filed: Jan. 21, 2015

Related U.S. Application Data
(63) Continuation-in-part of application No. 14/133,430, filed on Dec. 18, 2013.
(60) Provisional application No. 61/739,670, filed on Dec. 19, 2012.

(51) Int. Cl. G06F 19/00; G06T 7/20; G06T 11/60

(52) U.S. Cl. CPC G06F 19/321; G06T 11/60; G06T 7/2046; G06T 2207/10016; G06T 2210/41; G06T 2207/20221
USPC 345/633

(57) ABSTRACT

Methods and computing devices for measuring a range of motion of a musculoskeletal joint in a human or animal patient are provided.

### CROSS-REFERENCE TO RELATED APPLICATION

This application is a continuation-in-part of U.S. application Ser. No. 14/133,430 filed Dec. 18, 2013, which claims the benefit of U.S. Provisional Application No. 61/739,670 filed Dec. 19, 2012, the disclosures of which are incorporated by reference.

### FIELD OF INVENTION

This disclosure relates generally to methods and systems to measure deficiencies in musculoskeletal movement. In particular, this disclosure relates to tools for quantifying range of motion measurements.

### BACKGROUND

The term “Evidence-Based Medicine” or “Evidence-Based Practice” has been defined as the conscientious, explicit, and judicious use of current best evidence in making decisions about the care of individual patients. It integrates clinical expertise, patient values, and the best research evidence in the decision making process for patient care. Clinical expertise refers to the clinician's cumulated experience, education and clinical skills. A patient brings to the encounter his or her own personal preferences and unique concerns, expectations, and values. The best research evidence is usually found in clinically relevant research that has been conducted using sound methodology. While the evidence, by itself, is not determinative, it can help support the patient care process.

The value of the evidence depends on its reliability, objectivity, consistency, and validity. As applied in orthopedic practice, for example, where treatment often involves restoring range of motion to joints, it is important that data gathered from tools used to measure the range of motion (“ROM”) of a joint be reliable. The current gold standard for ROM measurement, the goniometer, has been studied extensively for its reliability and validity as a measuring tool. The goniometer has been found to be reliable when used correctly by a licensed practitioner, and the data collected over time is valid if the same practitioner takes the measurements. There are uncertainties, however, as to the reliability of goniometer data of a particular patient if various practitioners take the measurements over a period of time, in different exam environments. The issues with intra-measure and inter-tester reliability, as well as the accuracy of the reading itself, remain a concern.

Therefore, there is a need in the art for a process of collecting reliable and objective range of motion data that is not dependent on the skill of the practitioner taking the measurements.

### SUMMARY

A method for measuring a range of motion of a musculoskeletal joint of a human or animal patient is provided that includes receiving a first input from a user indicating an examination type; receiving a video stream and a data stream of a patient from a sensing device; determining a joint location associated with the examination type; generating a geometric shape overlay; superimposing the geometric shape overlay onto the received video stream of the patient; determining a range of motion (“ROM”) angle for the determined joint location based on the received data stream; sending the video stream with the superimposed geometric shape overlay and the determined ROM angle to a display device; and storing the determined ROM angle in a datastore.

In one embodiment, the method also includes retrieving from the datastore at least one previously determined ROM angle associated with the determined joint location of the patient; and presenting the determined ROM angle and the retrieved previously determined ROM angle in the form of a table, a graph, or a chart.

In another embodiment, the method further includes determining the patient's orientation with respect to the sensing device; comparing the determined orientation to a reference orientation; and providing an indication for orientation adjustment.

In one aspect of the embodiment, the received data stream of the patient includes locations of a plurality of joints.

In one embodiment, determining the ROM angle for the determined joint location includes determining a subset of the joint locations based on the examination type indication; determining a first vector and a second vector from at least two of the determined subset of joint locations; and calculating the ROM angle between the first vector and the second vector. The ROM angle may be a shoulder abduction angle, a scapula angle, a shoulder flexion angle, or a rotation angle.

In one embodiment, the determined joint location is a knee location and determining the ROM angle for the knee location includes applying a radius filter centered on the knee location to obtain an area of interest; estimating a first line in the area of interest that approximates a lower leg of the patient; estimating a second line in the area of interest that approximates an upper leg of the patient; and determining the ROM angle based on the angle formed by the first line and the second line. The ROM angle may be a knee supine angle or knee prone angle.

In one embodiment, the method further includes creating an avatar that performs desired examination movements; transmitting the avatar, the video stream with the superimposed geometric shape overlay, and the determined ROM angle to the display device; causing the transmitted avatar to be displayed in a first region of the display device; causing the video stream with the superimposed geometric shape overlay to be displayed in a second region of the display device; and causing the determined ROM angle to be displayed in a third region of the display device.

In one aspect of the embodiment, the geometric shape overlay includes at least two circle overlays and one line overlay, and superimposing the geometric shape overlay into the live video stream includes superimposing the two circle overlays over two joint locations, and superimposing the line overlay between the two joint locations.

In one embodiment, the method further includes providing feedback to the patient via an audible or visual indication on the display device, wherein the display device includes a horizontal bar indicating the patient's rotational position with respect to the sensing device, and a vertical bar indicating the patient's distance from the sensing device.

A computing device for measuring a range of motion of a musculoskeletal joint of a human or animal patient is provided that includes a processor and a memory that are respectively adapted to execute and store instructions that are organized into: a receiver to receive a first input from a user indicating an examination type, to receive a video stream of a patient from a sensing device, and to receive a data stream associated with the patient from the sensing device; a converter to determine a joint location associated with the examination type, to determine a range of motion angle for the determined joint location based on the received data stream, and to store the determined range of motion angle in a datastore; and a video controller to generate a geometric shape overlay, to superimpose the geometric shape overlay onto the received video stream of the patient, and to send the video stream with the superimposed geometric shape overlay and the calculated range of motion angle to a display device.

In one embodiment, the instructions are further organized into the converter to determine a subset of the joint locations based on the examination type indication, to determine a first vector and a second vector from at least two of the determined subset of joint locations, and to calculate the range of motion angle between the first vector and the second vector.

In another embodiment, the determined joint location is the patient's knee location, and the instruction to determine the range of motion angle for the knee location comprises instructions to apply a radius filter centered on the knee location to obtain an area of interest, estimate a first line in the area of interest that approximates a lower leg of the patient, estimate a second line in the area of interest that approximates an upper leg of the patient, and determine the range of motion angle based on the angle formed by the first line and the second line.

In another embodiment, the instructions are further organized into: the converter to retrieve from the datastore, at least one previously determined range of motion angle associated with the determined joint location of the patient, and the video controller to present the determined range of motion angle and the retrieved previously determined range of motion angle in a form of at least one of a table, graph, and chart.

A computer-readable storage medium having instructions stored therein for performing a process for measuring a range of motion of a musculoskeletal joint of a human or animal patient is provided, the process includes receiving, at a computing device, a first input from a user indicating an examination type, receiving a video stream of a patient from a sensing device, and receiving a data stream associated with the patient from the sensing device. The process further includes determining a joint location associated with the examination type, generating a geometric shape overlay, superimposing the geometric shape overlay onto the received video stream of the patient, determining a range of motion angle for the determined joint location based on the received data stream, and sending the video stream with the superimposed geometric shape overlay and the calculated range of motion angle to a display device.

In one embodiment, the determining the range of motion angle for the determined joint location comprises: determining a subset of the joint locations based on the examination type indication, determining a first vector and a second vector from at least two of the determined subset of joint locations, and calculating the range of motion angle between the first vector and the second vector.

### DESCRIPTION OF THE DRAWINGS

Non-limiting and non-exhaustive examples of the disclosure are described with reference to the following drawings. In the drawings, like reference numerals refer to like parts throughout the various figures unless otherwise specified. These drawings are not necessarily drawn to scale.

For a better understanding of the disclosure, reference will be made to the following Detailed Description, which is to be read in association with the accompanying drawings, wherein:

FIG. 1 is a functional block diagram of a system in which aspects of the disclosure may be implemented;

FIG. 2 is a logical flow diagram illustrating a process for movement conversion to a range of motion (“ROM”) of a patient's joint according to aspects of the disclosure;

FIG. 3 is a logical flow diagram illustrating the process to determine a shoulder ROM angle according to aspects of the disclosure;

FIG. 4A illustrates vectors and joint locations used to measure one or more angles in a shoulder abduction ROM tracking according to aspects of the disclosure;

FIG. 4B illustrates vectors and joint locations used to measure one or more angles in a shoulder flexion ROM tracking according to aspects of the disclosure;

FIG. 4C illustrates a live video image with superimposed geometric overlays according to aspects of the disclosure;

FIG. 5 is a logical flow diagram illustrating the process to determine a knee angle in a knee ROM tracking according to aspects of the disclosure;

FIG. 6A illustrates the knee location and lines used to measure a knee supine angle according to aspects of the disclosure;

FIG. 6B illustrates the knee location and lines used to measure a knee prone angle according to aspects of the disclosure;

FIG. 7 illustrates a plurality of display regions rendered on a display device according to aspects of the disclosure; and

FIG. 8 is a block diagram illustrating example hardware components of a computing device according to aspects of the disclosure.

### DETAILED DESCRIPTION

The following description provides specific details for a thorough understanding of, and enabling description for, various embodiments of the disclosure. One skilled in the art will understand that the disclosure may be practiced without many of these details. It is intended that the terminology used in this disclosure be interpreted in its broadest reasonable manner, even though it is being used in conjunction with a detailed description of certain embodiments of the disclosure. Although certain terms may be emphasized below, any terminology intended to be interpreted in any restricted manner will be overtly and specifically defined as such in this Detailed Description section. The term “based on” or “based upon” is equivalent to the term “based, at least in part, on” and thus includes being based on additional factors, some of which are not described herein. References in the singular are made merely for clarity of reading and include plural references unless plural references are specifically excluded. The term “or” is an inclusive “or” operator and is equivalent to the term “and/or” unless specifically indicated otherwise. For brevity, words importing the masculine gender shall include the feminine and vice versa.

Trauma, sport injuries, degenerative disease, infections and disorders involving musculoskeletal systems are the purview of orthopedic practice. Both surgical and non-surgical means are used as treatment. A patient is generally monitored before, during, and after treatment with periodic examination visits to the care provider's facility. During each examination visit, the patient is generally asked to answer a questionnaire to assess his or her functional status and the extent of his or her pain and/or disability. The answers to these questionnaires are stored as “functional scores” of the patient. In addition, the patient is asked to perform certain movements so that range of motion (“ROM”) measurements, for example, may be taken during such visit. Other measurements and/or parameters, for example gait kinematic parameters, or strength, may also be ascertained from the performed movements.

A system in which aspects of the disclosed technology are implemented may be described in the context of a patient's visit to his care provider for an examination. Upon arriving at the care provider's facility, the patient is provided with a tablet computer or other handheld device on which he can read and answer a questionnaire. His answers are then automatically stored to the system. This would be an improvement from a pen-and-paper questionnaire that has to be manually entered, a costly and error prone step, into the system.

After completing the questionnaire, the patient may be taken to an examination room, and positioned in front of a sensing device and a monitor. A physician assistant or a nurse may then enter the patient's information into the system and select an examination type, for example, left shoulder abduction, right shoulder flexion, right knee prone angle, and the like. During his visit, the patient may go through a session, which means a set of examinations, or examination types, and each examination assesses one range of motion, or calculates one angle.

Upon receiving the entries, the system brings up a graphical interface on the monitor and presents the patient with instructions on how to perform certain movements for one or more ROM measurements. The patient is then prompted by an indication on the monitor or by an audible invitation to begin his examination movements.

As the patient carries out his examination movements, a sensing device detects and/or captures his image and movements. The sensing device may include a single sensor or a combination of several sensors, and may detect sound, image, movements, spatial location, distance, and the like. One example of a sensing device is the Microsoft Kinect® that houses a video camera, Infrared camera, and microphones.

The sensing device may send one or more data streams to the system. The data streams include at least the spatial location of the patient, and spatial locations of the patient's joints tracked by the sensing device as the patient moves. The sensing device may also send a live video stream of the patient to the system.

Upon receiving the data streams from the sensing device, the system translates the joint locations to movement data and converts them to reliable ROM measurements of the patient. Processing the data streams from the sensing device, the system quickly and efficiently determines the patient's ROM based on changes to the patient's joint locations as he performs his examination movements. ROM measurements determined in this way are objective and reliable as operator bias is removed. Multiple ROM measurements taken by the system of the same patient are consistent and reliable. ROM measurements taken by the system across multiple patients are objective and reliable. The methods of the present disclosure are in contrast to and an improvement over the use of a goniometer to manually measure range of motion. The system can convert the movement data to reliable ROM measurements quickly, therefore more of the visiting time can be used for personal interaction between the patient and his physician.

When the patient has completed his examination movements, the system stores the determined ROM measurements in a datastore. When the physician comes in to discuss the examination results with the patient, she brings up a visit summary on a monitor so that she and the patient can review the results, as well as any progress the patient has made. The visit summary lists the results of the present examination as well as results from one or more prior examinations, and shows the patient's ROM measurements, previously measured and current, in the form of a graph, a table, a chart, or a combination thereof. By viewing a chronological graph of the patient's ROM measurements, for example, the physician and patient can discuss the progress or lack thereof, and the effect of a treatment on a measurement. The visit summary on the monitor may be interactive; the physician may change a view by selecting one or more elements on the monitor screen, using a pointing device, her voice, or by touching the monitor itself.

The system may then send the visit summary to a printer. In one embodiment, the visit summary includes a still image of the patient performing his range of movement examination captured at the maximum angle achieved during the examination. The system may be considered as a movement converter system.

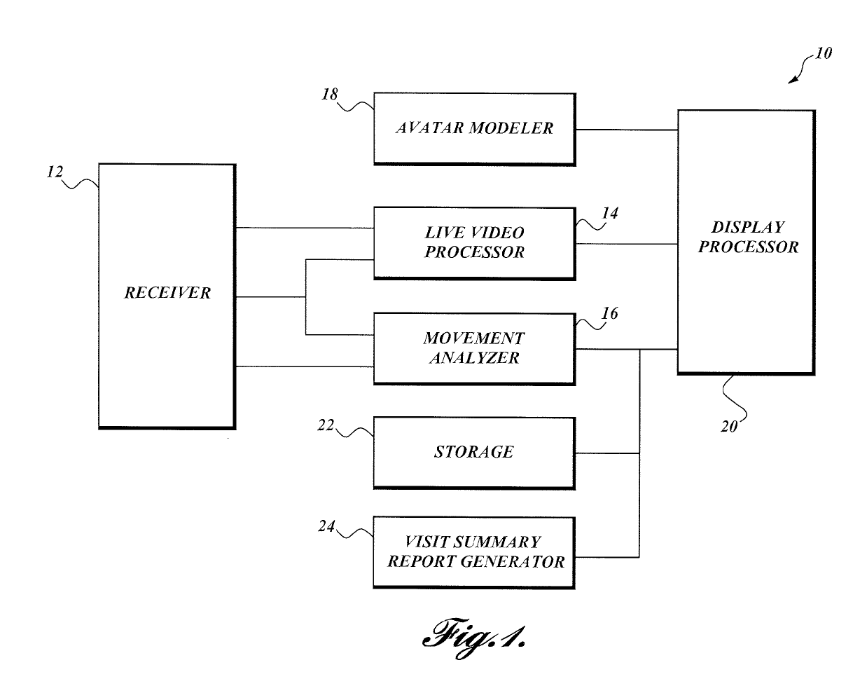

FIG. 1 shows a functional block diagram of a movement converter system 10 in which the aspects of the disclosure may be implemented. Functional modules in movement converter system 10 as shown in FIG. 1 include receiver 12 coupled to live video processor 14 and movement analyzer 16. Movement converter system 10 in FIG. 1 further includes modeler 18, display processor 20, storage 22, and report generator 24. The movement converter system may include less or more functional modules, and may be a stand-alone device, or a subsystem in a device or an element of a larger system. The functional modules may be combined or each may be broken down into sub modules. The movement converter system and each functional module may be implemented in hardware, firmware, software, or a combination thereof. Movement converter system 10 in FIG. 1 may be implemented in a computing device, or in multiple computing devices.

Receiver 12 may be adapted to receive input from a sensing device. The input may include one or more data streams. In one embodiment, receiver 12 receives live color video stream and data streams that embed an object's image and movement. In one aspect of the embodiment, receiver 12 receives a live color video stream of a patient, a skeleton stream, and a depth stream of the patient from a sensing device. Receiver 12 may send a video stream to live video processor 14.

Live video processor 14 may be adapted to generate overlays and to superimpose one or more overlays on a received video stream. WPF objects, canvas drawings, or other methods may be used to generate overlays. In one embodiment, live video processor 14 receives multiple joint locations from movement analyzer 16, maps the received joint locations to the patient image in the video stream, and moves and/or superimposes one or more overlays to the mapped joint locations on the image. In one aspect of the embodiment, live video processor 14 also generates and superimposes lines overlays between the overlays on the joint locations. Live video processor 14 may further be adapted to generate a modified color video stream that includes the received video stream and one or more superimposed overlays, and to send the modified color video stream to display processor 20.

Movement analyzer 16 may be adapted to receive data streams embedded with the object's image and movement. In one embodiment, movement analyzer 16 receives the skeletal stream and depth stream from receiver 12. The depth stream may include a depth matrix that represents distances from the sensing device, in millimeters. The depth stream may also include an identification matrix of values between 0 and 5, each value representing an identification of a recognized body in the scene, for example, “1” identifies the patient, and “4” identifies the physician. In one embodiment, the identification values are used to distinguish the patient from other bodies sensed by the sensing device. In one embodiment, the depth matrix and the identification matrix have the same size, and their elements map 1:1 (one-to-one), and the identification matrix is used to select distances of interest from the depth matrix.

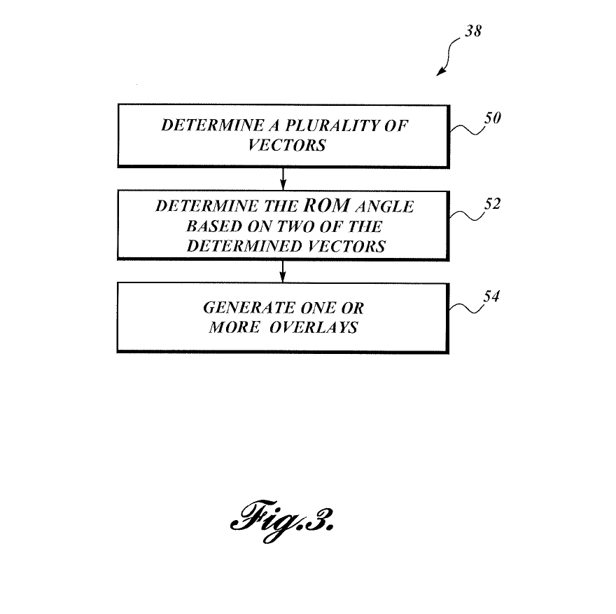

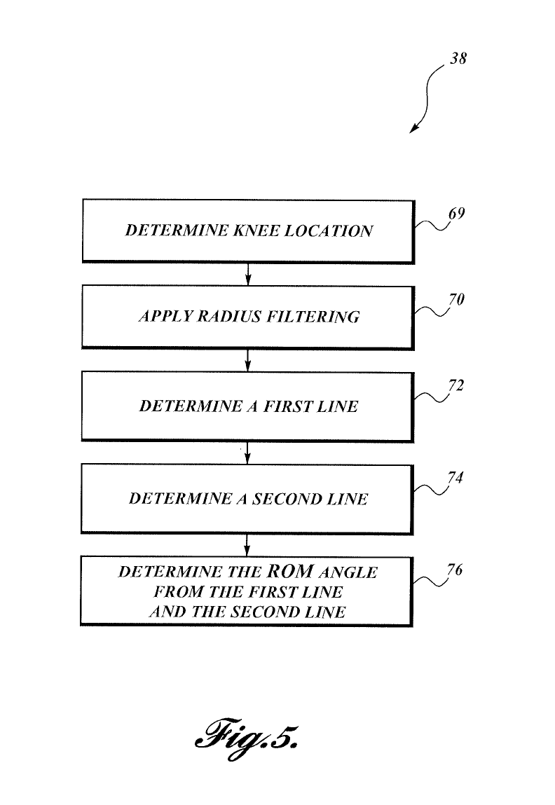

Movement analyzer 16 may be further adapted to convert information in the data streams to one or more quantifiable measures. In one embodiment, movement analyzer 16 converts joint locations information in the skeletal and/or depth streams into range of motion measurements in degrees. Movement analyzer 16 may also convert the received data stream to other measurements, for example strength, kinematic parameters, center of mass, patient's features (e.g. height, limbs' lengths, waist), facial expression, or patient's speech. Embodiments of a conversion process will be explained in detail when FIGS. 3 and 5 are discussed below.

Movement analyzer 16 may be adapted to send the measurements to display processor 20, and to storage 22. It is also contemplated that movement analyzer 16 also sends the measurements to a remote storage location, a server, or a remote system via a communication network.

In one embodiment, modeler 18 is adapted to generate graphical representations of a person (e.g. an avatar) that performs certain examination movements. In one embodiment, modeler 18 is adapted to send an avatar that performs an examination movement to be imitated by a patient, to display processor 20.

Display processor 20 may be adapted to receive measurements from movement analyzer 16, modified color video stream with one or more overlays from live video processor 14, and a moving avatar from modeler 18, and to generate an output that causes a display device to present them in separate display regions. Display processor 20 may also be adapted to send the output to a display device.

Report generator 24 may be adapted to receive measurements from movement analyzer 16 and previous visit data from storage 22. Report generator 24 may also be adapted to receive still images of the patient from live video processor 14. Report generator 24 may be further adapted to create a visit summary for the patient. In one embodiment, the visit summary includes the current measurements for each examination type the patient has just completed and a comparison, in the form of a table, chart, graph, or combination thereof, of measurements between visits. In one aspect of the embodiment, the visit summary includes a still image of the patient.

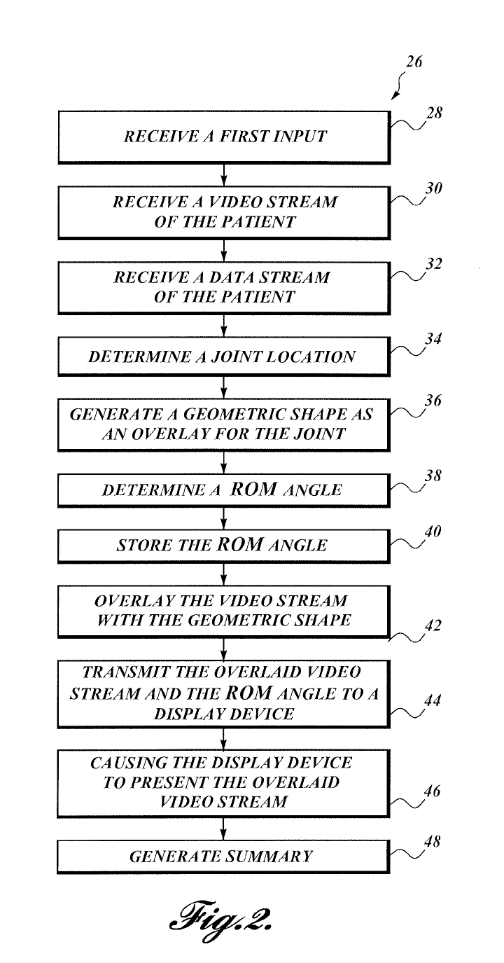

FIG. 2 is a logical flow diagram illustrating process 26 that may be performed by an apparatus having functional modules described in FIG. 1. Other devices or apparatus may also be used to implement process 26. The process, as well as other processes described herein, are described for clarity in terms of operations performed in particular sequences by particular devices or elements of a system. It is noted, however, that this process and other processes described herein, are not limited to the specified sequences, devices, or elements. Certain processes may be performed in different sequences, in parallel, be omitted, or supplemented by additional processes, whether or not such different sequences, parallelism, or additional processes are described herein. The processes disclosed may also be performed on or by other devices, elements, or systems, whether or not such devices, elements, or system are described herein. These processes may also be embodied in a variety of ways, for example, on an article of manufacture, e.g. as a computer-readable instructions stored in a computer-readable storage medium, or be performed as a computer-implemented process. These processes may also be encoded as computer-executable instructions and transmitted via a communication medium.

Process 26 begins at 28 where a first input from a user indicating an examination type is received. Depending on the patient and/or his treatment, his care provider may be interested in examining one or more ranges of motion of one or more joints. For example, for a patient who underwent a knee replacement surgery, the physician may be interested in measuring the range of motion of the knee joints in both supine and prone positions, in which case, two separate examinations would be undertaken.

An examination type of “knee supine angle” may be received as the first input from the user. In one embodiment, the first input is received directly at the system. In one aspect of the embodiment, the first input is received at a computing device. The examination type input may be received by a receiving module (for example, receiver 12 in FIG. 1), and used to generate (for example, by modeler 18 in FIG. 1) an appropriate avatar to be displayed to the patient.

Process 26 continues to 30, where a video stream of the patient being examined is received. In one embodiment, a live color video stream of the patient is received. Still images of the patient when he is performing his examination movements may be captured and stored. A receiving module, for example receiver 12 in FIG. 1, may receive the video stream and capture still images from the video stream.

Process 30 then flows to 32 where a data stream is received from a sensing device. More than one data stream may be received at 32. The data stream may contain information related to the location or position of the patient relative to the sensing device or other reference point. In one embodiment, the data stream includes a skeleton stream having one or more frames with joint locations in the form of a three dimensional coordinate for each joint, as identified by the sensing device. In another embodiment, the data stream includes a depth stream having pixels with values representing the distance between the surface areas of the patient and the sensing device. It is contemplated that more than one data stream may be received from a sensing device. As the patient performs his examination movements, changes to the joint locations may be reflected in the received data stream. Receiver 12 in FIG. 1 may receive the one or more data streams from the sensing device.

Process 26 continues to 34 where, based on the examination type input by the user, the locations of one or more joints of interest are determined, as well as their movements. In one embodiment, in a shoulder abduction ROM tracking examination, the joint of interest may be the left shoulder joint and the location of the left shoulder joint is determined in process 34. In another embodiment, in a knee supine ROM tracking examination, the knee may be the joint of interest, and the location of the knee is determined in process 34.

In one embodiment, a plurality of joint locations and their movements are available in a skeletal data stream, and the movements of joint locations appropriate to measure a scapula angle, for example the left shoulder, spine-shoulder, and spine-mid joints, are determined. Movement analyzer 16 as shown in FIG. 1 may implement this process.

Process 34 flows to 36 where an overlay object in a geometric shape is generated and associated with an identified joint location. In one embodiment, a circle overlay object is created and associated with the identified joint location. Overlay objects of different geometric shapes, for example a rectangle, triangle, and the like, may also be used. It is contemplated that the overlay may have a color. In one embodiment, a video processing module (e.g. live video processor 14 in FIG. 1) creates the overlay and superimposes it on a video stream based on the joint location information received from the data stream analyzer (e.g. movement analyzer 16 in FIG. 1).

Process 26 continues to 38 where the ROM angle is determined or calculated. There are several ROM angles that may be calculated, for example shoulder abduction angle, scapula angle, shoulder flexion angle, rotation angle, knee supine angle, knee prone angle, and the like. The type of examination, or examination type, may determine the angle or angles to be measured. Different embodiments of process 38 are illustrated in FIG. 3 and FIG. 5, and will be discussed when they are described in detail. This ROM angle determination process may be implemented in movement analyzer 16 in FIG. 1.

In one embodiment, one or more still images of the patient as he performs his examination movements are captured from the received video stream.

Process 38 flows to 40 where the determined ROM angle is stored in a storage device or datastore. The ROM angle may be stored in one or more storage devices. In one embodiment, the ROM angle is stored locally, in the same device that performs the ROM measurements. In an aspect of the embodiment, the ROM angle is also stored in a server or other computing device separate from the device that performs the ROM measurements. The stored ROM angle is associated with the patient. Still images of the patient may be stored together with the ROM angle. Movement analyzer 16 in FIG. 1 may store the determined ROM angle in storage 22, an example of a storage device, in FIG. 1.

Process 40 continues to 42 where a video stream with one or more overlays is prepared. The overlays superimposed on the received video stream may be based on the examination type, for example, overlays for a shoulder elevated rotation examination (e.g. two circles superimposed on two joint locations on a lower arm, and a line overlaid between the circles) may differ from overlays for a shoulder abduction examination (e.g. three circles superimposed on three joint locations on one arm, and two lines each overlaid between the two circles). Dashed line overlay may also be superimposed on the video stream to indicate the starting position of a movement. A video processing module, for example live video processor 14 in FIG. 1, may implement this process.

Process 42 flows to 44 where the video stream with the superimposed geometric shape overlay is transmitted along with the measured ROM angle to the display device. Additional information, for example ROM angles measured during previous visits by the patient, and/or graphics representing changes in the measured ROM angles as the patient performs his examination movements, may also be transmitted to the display device. Display processor 20 in FIG. 1 may implement this process.

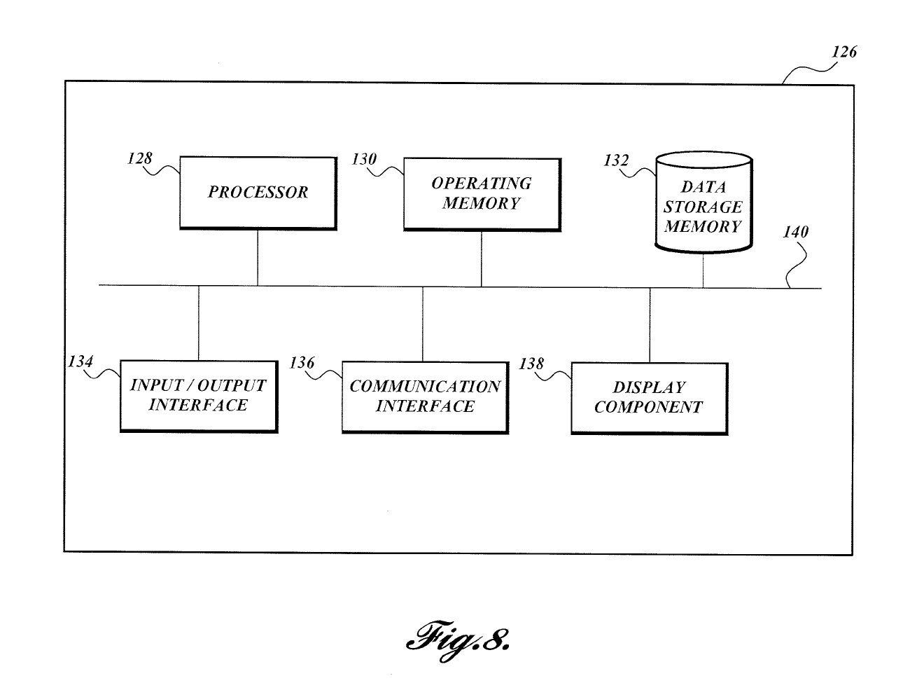

Process 38 continues to 46 where the display device is caused to present the video stream with the superimposed geometric shape overlay along with data associated with the measured ROM angle in a plurality of display regions. In one embodiment, the display device is caused to also present an avatar that provides movement guidelines to the patient. Display processor 20 in FIG. 1 may implement this process. One example of this presentation on a display device is shown in FIG. 7, which will be discussed in detail below.

Process 46 flows to 48 where a visit summary is presented to the patient. In one embodiment, a visit summary may be sent to the display device. In another embodiment, a visit summary may be transmitted to a printing device. A visit summary may include, for each examination type, current and previously measured ROM angles. A table, chart, graph or combination thereof may be used to display the different measurements. In one embodiment, a visit summary includes a graph indicating ROM angles for each examination type at every exam visit. The visit summary provides a concise look at the patient's progress, or lack thereof. In one aspect of the embodiment, the visit summary includes a still image of the patient performing his examination movement at the maximum angle. Report generator 24 of the movement converter system in FIG. 1 may implement this process.

An example of process 38 is illustrated in the logical flow diagram of FIG. 3. As shown in FIG. 3, process 38 starts at 50 where a plurality of vectors, originating from the joint location of interest, is determined. In one embodiment, two vectors are determined from the joint location of interest to at least two neighboring joint locations. Additional vectors from any neighboring joint may also be determined. A “reference vector” from the joint location of interest that parallels another vector may also be determined; the reference vector being a vector with an origin at the joint location of interest but without a joint location as its destination. The neighboring joints of the joint location of interest may vary depending on the examination type and the ROM angle to be measured.

Process 50 flows to 52 where the angle formed by the two vectors is determined. In one embodiment, the two vectors form an angle that is calculated and presented as the ROM angle, in degrees. In one embodiment, the ROM angle is calculated using the dot product of the two vectors. Other methods for determining the angle formed by two intersecting vectors are also contemplated.

Process 38 in FIG. 3 continues to 54 where one or more additional overlays may be generated to be superimposed on additional joints locations and between joint locations. The additional joint locations may be selected from the neighboring joints of the joint location of interest. Joint locations that are not immediately next to the joint location of interest may also be selected for overlay. In one embodiment, the overlays are created in geometric shapes. In one embodiment, circle overlays are generated for joint locations, and straight line overlays are generated for connection between the circle overlays.

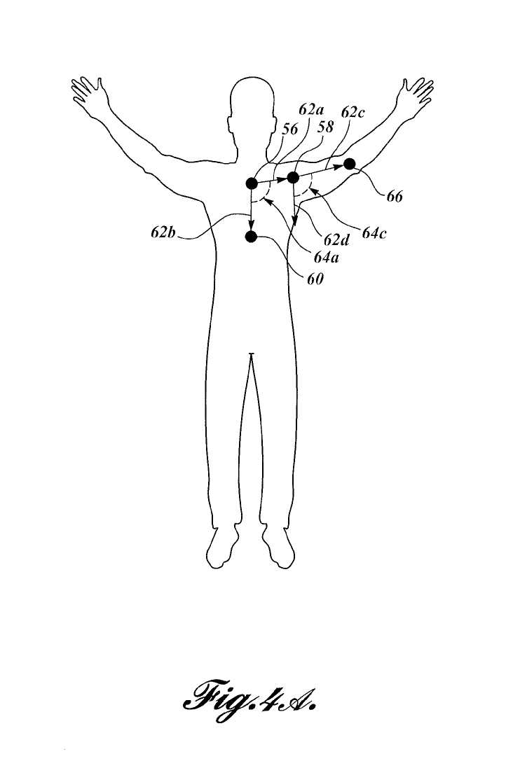

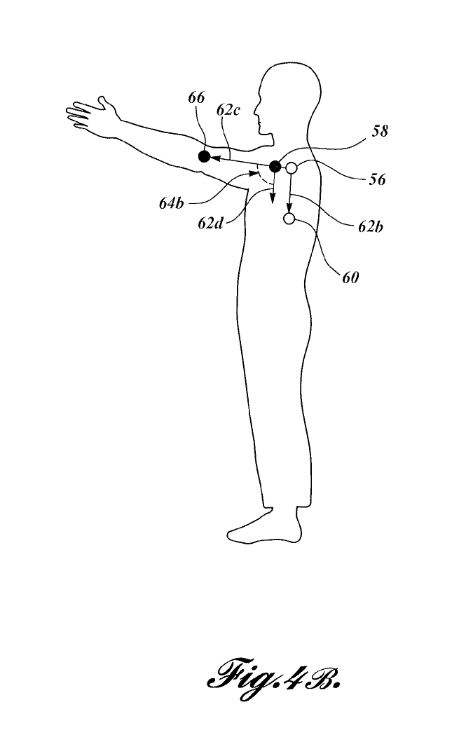

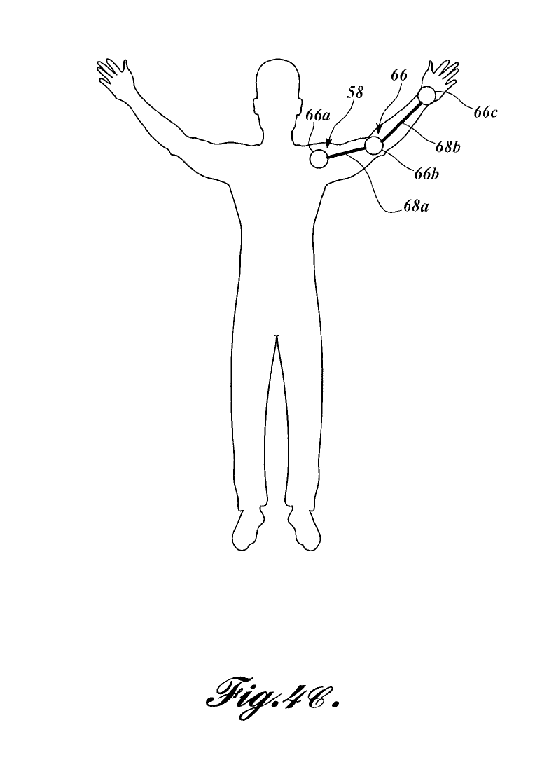

Examples of joint locations, vectors, and ROM angles are shown in FIGS. 4A and 4B. FIG. 4C illustrates an example of overlays superimposed on and between joint locations.

FIG. 4A shows some of the joints locations of a patient with an arm raised on his side. These joint locations may be provided in the data stream received from a sensor. As shown in FIG. 4A, first joint 56, second joint 58, third joint 60, and fourth joint 66 are joint locations for determining one or more angles (e.g. scapula angle, shoulder abduction angle) of a shoulder abduction ROM tracking. Also shown in FIG. 4A are vectors 62a-d, and angles 64a, 64c. The data stream may be received from, for example, Microsoft's Kinect® v2 product. For example, in the data streams generated by Microsoft Kinect® v2 first joint 56 is referred to as spine-shoulder, second joint 58 is referred to shoulder-left, third joint 60 is referred to as spine-mid, and fourth joint 66 is referred to as wrist-left. Other references to these joint locations may also be used. For simplicity and readability, the Microsoft Kinect® v2 enumeration of these joint locations is used in this description.

In one embodiment, to determine a scapula angle, illustrated as angle 64a in FIG. 4A, based on the received data stream, two vectors originating from the spine-shoulder are determined: a vector between spine-shoulder and shoulder-left, and a vector between spine-shoulder and spine-mid (vectors 62a and 62b respectively in FIG. 4A). Even though each joint location may be represented by a three-dimensional coordinate, the joint locations and vectors in FIG. 4A are shown only in the two dimensional X-Y plane. A different ROM angle measurement may lead to a different set of joint locations and determined vectors.

In one aspect of the embodiment, to determine the shoulder abduction angle, illustrated as angle 64c in FIG. 4A, two vectors originating from the shoulder-left are determined: a vector between shoulder-left and elbow-left, and a vector from shoulder-left downward and parallel to the vector between spine-shoulder and spine-mid (vectors 62c and 62d respectively in FIG. 4A).

FIG. 4B shows the joint locations, determined vectors, and one ROM angle that is measured in a shoulder flexion tracking examination. FIG. 4B shows joint locations on a patient with an arm raised in front of his body, in the Y-Z plane. A shoulder flexion examination may measure a shoulder flexion angle and a scapula angle. Shown in FIG. 4B are first joint 56, second joint 58, third joint 60, fourth joint 66, vectors 62a-d, and angle 64b. Using the Microsoft Kinect® v2 enumeration, first joint 56 is spine-shoulder, second joint 58 is shoulder-left, third joint 60 is spine-mid, and fourth joint 66 is elbow-left. Vector 62b is determined between spine-shoulder and spine-mid. In one embodiment, to measure a shoulder flexion angle, the shoulder-left joint is the joint location of interest, and vector 62c from shoulder-left to elbow-left is determined as well as vector 62d that is a reference vector parallel to vector 62b. In one aspect of the embodiment, angle 64b is the shoulder flexion angle, determined from vectors 62c-d.

As shown in FIG. 4C, circle overlays 66a-c are placed on the locations of second joint 58, fourth joint 66 and fifth joint (not shown), or to use Microsoft Kinect® v2 enumeration, shoulder-left, elbow-left, and wrist-left respectively. Also shown in FIG. 4C are the straight line overlay 68a that is placed between overlays 66a and 66b, and straight line overlay 68b that is placed between overlays 66b and 66c. More overlays may be placed on and/or between additional joint locations.

In one embodiment, the example of process 38 as illustrated in the logical flow diagram in FIG. 3 is used to measure ranges of motion of a patient's shoulders.

Another example of process 38 is illustrated in the logical flow diagram of FIG. 5. Process 38 in FIG. 5 begins at 69 where the location of a knee is determined from the received data stream. In one embodiment, the knee location is determined from a depth data stream. As previously discussed, the depth data stream may include a depth matrix and an identification matrix, and the location of the patient may be determined by identifying him in the depth matrix using the identification matrix.

In one embodiment, the upper body of a supine or prone patient is filtered out prior to determining the knee location in the depth matrix, leaving only pixels or data of the patient's lower body. Different methods to identify pixels in the depth matrix that are associated with the upper body and/or lower body may be used, and the pixels associated with the upper body may be discarded, normalized, or otherwise ignored.

In one aspect of the embodiment, for example to determine a knee supine angle, the knee location is determined by identifying for the “highest point” (when considered as an image) in the lower body pixel matrix. In another aspect of the embodiment, for example to determine a knee prone angle, the knee location is determined by identifying the “lowest point” in the lower body pixel matrices.

In one embodiment, the radius filter is centered on determined knee location. A double radius filter, having an inner radius and an outer radius, filters out data in the frames that are “outside” the outer radius and “inside” the inner radius. A single radius filter filters out data in the frames that are “outside” the radius. The radius may be determined based on the height of the patient.

Process 69 flows to 70 where a radius filter is applied to the received data stream, centering on the determined knee location. A radius filter as used in this specification is a filter to select an area of interest, i.e. one or more data points (e.g. pixels) for further consideration. The radius filter may be a single radius, and the area of interest may be the circular area of said radius. The radius filter may also be a double radius filter, in which case the area of interest may be an annular area between the circle of the first radius and the circle of the second radius. In one embodiment, the data stream includes frames with a depth matrix or a matrix of pixels, where each pixel indicating the distance between a sensing device and one or more objects it senses. In one aspect of the embodiment, an image of the patient is represented by the pixel values in the matrices. The data stream may also include an identification matrix of values between 0 and 5, each value representing an identification of a recognized body in the scene, for example, “1” identifies the patient, and “4” identifies the physician. The identification values may be used to distinguish the patient from other objects sensed by the sensing device. In one embodiment, the depth matrix and the identification matrix have the same size, and their elements map 1:1 (one-to-one), and the identification matrix is used to select distances of interest from the depth matrix.

Process 70 flows to 72 where a first line that approximates a lower leg position is determined. The lower leg, for the purpose of this specification, is the part of the leg between the knee and the foot. Data not filtered out by the radius filter may be scanned, for example by scanning the filtered pixels in the frames to detect edges or outline of the lower leg. In one embodiment the first line is determined by applying a linear regression algorithm to the detected outline.

Process 72 flows to 74 where a second line that approximates an upper leg position is determined. The upper leg, for the purpose of this specification, is the part of the leg between the knee and the hip. Similar to process 80, data not filtered out by the radius filter may be scanned to detect the edges or outline of the upper leg, and the second line may be determined by applying linear regression algorithm to the detected outline.

Process 38 in FIG. 5 continues to 76 where the ROM angle is determined based on the first line and the second line. In one embodiment, the first line and the second line may be extrapolated to intersect at a point at or near the knee and the angle formed by the first line and the second line is the ROM angle.

It is contemplated that the example of process 38 as illustrated in the logical flow diagram in FIG. 5 is used to measure ranges of motion on the knee joints.

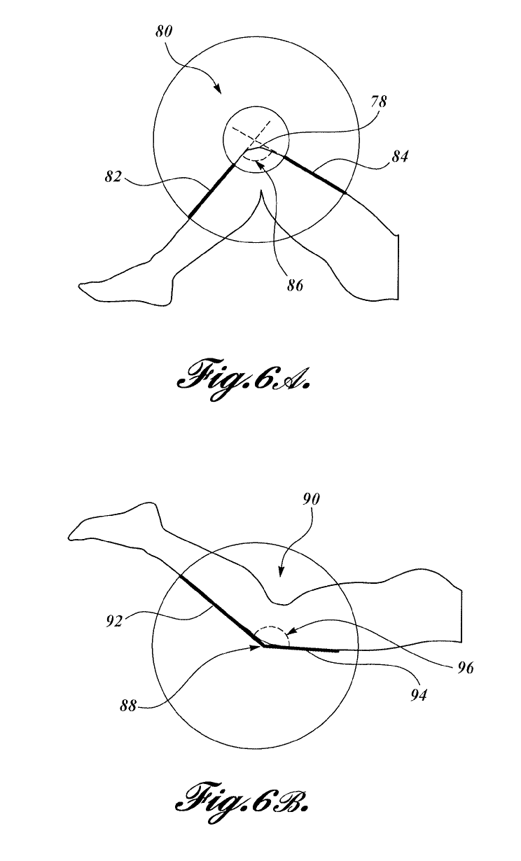

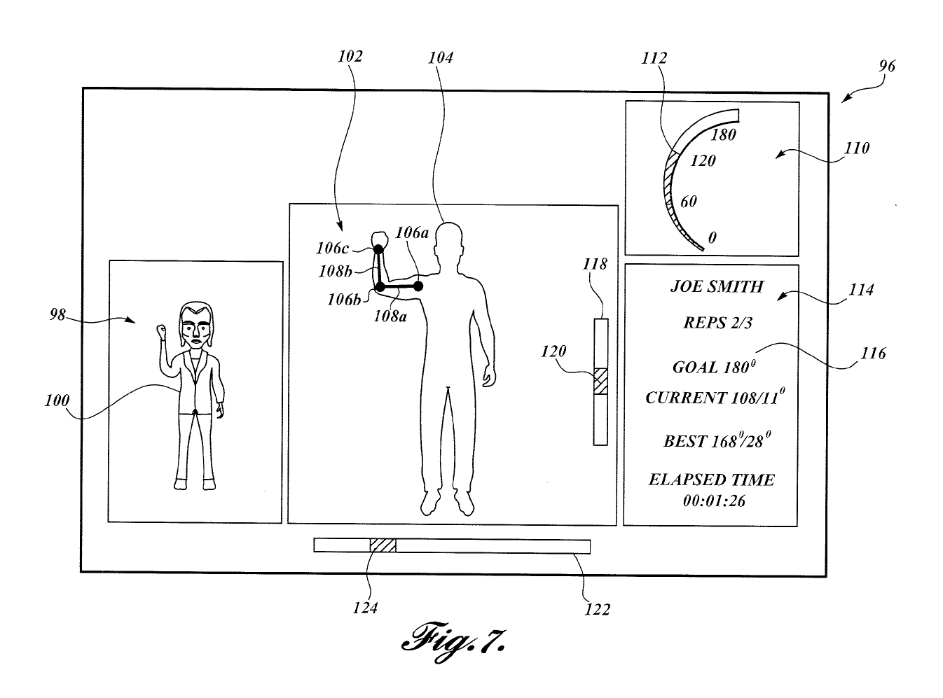

FIGS. 6A and 6B illustrate the joint locations of interest, the lines and the ROM angles in a knee supine angle and knee prone angle measurements, respectively. FIG. 6A illustrates an image of a supine patient with his knee raised, his upper body having been filtered out. As shown in FIG. 6A, the knee 78 is the joint location of interest, the highest point in the image. In one embodiment, a double radius filter is applied to find a knee supine angle. As shown in FIG. 6A, when a double radius filter 80 is applied, a relevant area bounded by the inner and outer radius remains for subsequent processing to find the knee supine angle. First line 82 and second line 84 are shown extrapolated toward each other and intersect to form angle 86. In one embodiment, angle 86 is the ROM measurement in a knee supine angle examination.

FIG. 6B illustrates an image of a prone patient with his lower leg raised, his upper body having been filtered out. The knee 88 in FIG. 6B is the joint of interest as it is the lowest point in the image. In one embodiment, a single radius filter is applied to find a knee prone angle. As shown in FIG. 6B, when the single radius filter 90 is applied, a relevant area bounded by the radius remains for subsequent processing to find the knee prone angle. First line 92 and second line 94 are shown extrapolated towards each other and intersect to form angle 96. In one embodiment, angle 96 is the ROM measurement in knee prone angle examination.

FIG. 7 illustrates a graphical interface as presented on a display device. In FIG. 7, the graphical interface on display device 96 includes first region 98, second region 102, third region 110, and fourth region 114. In FIG. 7, first region 98 shows at least animated avatar 100 demonstrating the examination movements, and second region 102 shows at least a modified live video image 104 of the patient, the modified live video image 104 having been superimposed with circles 106a-c and lines 108a-b overlays. In one embodiment, as the patient moves, the image of the patient, as well as the superimposed circles 106a-c and lines 108a-b overlays in the modified live video image 104 also move. For example, as the patient moves his lower arm up and down in a shoulder elevated rotation examination, circle 106a-b and line 108a overlays may move to follow their respective joint locations that change due the movement of the patient's lower arm.

In FIG. 7, third region 110 shows at least graphical representation 112 of the real time ROM measurements of the patient's joint that is being examined. For example, when a rotation angle is being measured, graphical representation 112 displays a graph with the range of 0 to 180 degrees. In one example, changes in real time ROM measurement of a rotation angle is represented with changes of a marker location along the graph, as well as the marker's color.

Fourth region 114 as shown in FIG. 7 shows alphanumeric information 116 of the ongoing examination. In one embodiment, alphanumeric information 116 includes the name of the patient, the goal angle that he should attempt to achieve, and the measured angle. Additional information, for example the greatest angle the patient managed to make during the examination, the number of repetitions, and the like, may also be included.

The graphical interface shown in FIG. 7 may include horizontal bar 122 and vertical bar 118 to provide a patient with feedback regarding his position, posture, and/or bearing relative to the sensing device. Horizontal bar 122 may indicate rotational position of a patient with rotation marker 124 moving further to one side of horizontal bar 122 as the patient rotates further to his left, and moves further to the other side as the patient rotates further to his right. Rotation marker 124 may change color as a patient moves toward and away from a preferred rotational position, for example, rotation marker 124 becoming green as the patient approaches a preferred rotational position.

Vertical bar 118 may provide feedback to a patient with regard to his distance from a sensing device. In one embodiment, a patient is preferred to be eight (8) feet away from the sensing device. Distance marker 120 in vertical bar 118 may indicate how close a patient is to being at a preferred distance, distance marker 120 moving to the middle of vertical bar 118 bar when the patient is approximately at the preferred distance. It is contemplated that distance marker 120 becomes green in color as it gets closer to the middle of vertical bar 118; when a patient gets closer to being at the preferred distance. Additional feedback indications for a patient may be provided in the graphical interface.

FIG. 8 is a high-level illustration of example hardware components of a computing device, which may be used to practice various aspects of the disclosure. Computing device 126 in FIG. 8 may be employed to perform process 26 of FIG. 2. As shown, computing device 126 includes processor block 128, operating memory block 130, data storage memory block 132, input/output interface block 134, communication interface block 136, and display component block 138. These aforementioned components may be interconnected by bus 140.

Computing device 126 may be virtually any type of general- or specific-purpose computing device. For example, computing device 126 may be a user device such as a desktop computer, a laptop computer, a tablet computer, a display device, a camera, a printer, or a smartphone. Likewise, computing device 126 may also be server device such as an application server computer, a virtual computing host computer, or a file server computer.

Computing device 126 includes at least one processor block 128 adapted to execute instructions, such as instructions for implementing the above-described processes. The aforementioned instructions, along with other data (e.g., datasets, metadata, operating system instructions, etc.), may be stored in operating memory block 130 and/or data storage memory block 132. In one example, operating memory block 130 is employed for run-time data storage while data storage memory block 132 is employed for long-term data storage. However, each of operating memory block 130 and data storage memory block 132 may be employed for either run-time or long-term data storage. Each of operating memory block 130 and data storage memory block 132 may also include any of a variety of data storage devices/components, such as volatile memories, semi-volatile memories, non-volatile memories, random access memories, static memories, disks, disk drives, caches, buffers, or any other media that can be used to store information. However, operating memory block 132 and data storage memory block 132 specifically do not include or encompass communications media, any communications medium, or any signals per se.

Also, computing device 126 may include or be coupled to any type of computer-readable media such as computer-readable storage media (e.g., operating memory block 132 and data storage memory block 132) and communication media (e.g., communication signals and radio waves). While the term computer-readable storage media includes operating memory block 130 and data storage memory block 132, this term specifically excludes and does not encompass communications media, any communications medium, or any signals per se.

Computing device 126 also includes input/output interface block 134, which may be adapted to enable computing device 126 to receive input from users or other devices, or to send output to user or other devices. In addition, input/output interface block 134 may be adapted to transmit data to display component block 138 to render displays. In one example, display component block 138 includes a frame buffer, graphics processor, graphics accelerator, or a virtual computing host computer and is adapted to render the displays for presentation on a separate visual display device (e.g., a monitor, projector, virtual computing client computer, etc.). In another example, display component block 138 includes a visual display device and is adapted to render and present the displays for viewing.

Computing device 126 may include communication network block 136 which may be adapted to transmit data to a communication network via a wired or wireless communication link.

ROM angles measured with the disclosed technology may be collected over many examination visits and from a large number of patients. It is contemplated that because this data collection can be done rapidly, objectively, consistently, and reliably, the stored information may be used to evaluate the efficacy of a treatment and to predict an outcome of a hypothetical treatment plan.

While illustrative embodiments have been illustrated and described, it will be appreciated that various changes can be made therein without departing from the spirit and scope of the disclosed technology; the technology can be practiced in many ways. Particular terminology used when describing certain features or aspects of the technology should not be taken to imply that the terminology is being redefined herein to be restricted to any specific characteristics, features, or aspects with which that terminology is associated. In general, the terms used in the following claims should not be construed to limit the technology to the specific examples disclosed herein, unless the Detailed Description explicitly defines such terms. Accordingly, the actual scope of the technology encompasses not only the disclosed examples, but also all equivalent ways of practicing or implementing the technology.

I claim:

1. A method for measuring a range of motion of a musculoskeletal joint in a human or animal patient, the method comprising:
receiving, at a computing device, a first input from a user indicating an examination type;
receiving a video stream of a patient from a sensing device;
receiving a data stream associated with the patient from the sensing device;
determining a joint location associated with the examination type;
generating a geometric shape overlay;
superimposing the geometric shape overlay onto the received video stream of the patient;
determining a range of motion angle for the determined joint location based on the received data stream;
sending the video stream with the superimposed geometric shape overlay and the calculated range of motion angle to a display device; and
storing the determined range of motion angle in a datastore.

2. The method of claim 1, further comprising:
retrieving from the datastore, at least one previously determined range of motion angle associated with the determined joint location of the patient; and
presenting the determined range of motion angle and the retrieved previously determined range of motion angle in a form of at least one of a table, graph, and chart.

3. The method of claim 1, further comprising:
determining an orientation of the patient with respect to the sensing device;
comparing the determined orientation to a reference orientation; and
providing an indication for orientation adjustment.

4. The method of claim 1, wherein the received data stream of the patient includes locations of a plurality of joints, and
wherein determining the range of motion angle for the determined joint location comprises:
determining a subset of the joint locations based on the examination type indication;
determining a first vector and a second vector from at least two of the determined subset of joint locations; and
calculating the range of motion angle between the first vector and the second vector.

5. The method of claim 4, wherein the range of motion angle is one of shoulder abduction angle, scapula angle, shoulder flexion angle, and rotation angle.

6. The method of claim 1, wherein the determined joint location is the patient's knee location, and
wherein determining the range of motion angle for the knee location comprises:
applying a radius filter centered on the knee location to obtain an area of interest;
estimating a first line in the area of interest that approximates a lower leg of the patient;
estimating a second line in the area of interest that approximates an upper leg of the patient; and
determining the range of motion angle based on the angle formed by the first line and the second line.

7. The method of claim 6, wherein the range of motion angle is one of knee supine angle and knee prone angle.

8. The method of claim 1, further comprising:
creating an avatar that performs desired movements;
transmitting the avatar, the video stream with the superimposed geometric shape overlay, and the determined range of motion angle to the display device;
causing the transmitted avatar to be displayed in a first region of the display device;
causing the video stream with the superimposed geometric shape overlay to be displayed in a second region of the display device; and
causing the determined range of motion angle to be displayed in a third region of the display device.

9. The method of claim 1, wherein the geometric shape overlay includes at least two circle overlays and one line overlay; and
wherein superimposing the geometric shape further comprises:
superimposing the two circle overlays over two joint locations; and
superimposing the line overlay between the two joint locations.

10. The method of claim 1 further comprising:
superimposing a broken line overlay on the video stream indicating a starting position for a range of motion examination movement.

11. The method of claim 1, further comprising:
providing feedback to the patient via at least one of audio and graphical indication on the display device; wherein
the display device includes a horizontal bar indicating the patient's rotational position with respect to the sensing device; and a vertical bar indicating the patient's distance from the sensing device.

12. A computing device for measuring a range of motion of a musculoskeletal joint in a human or animal patient, comprising:
a processor and a memory that are respectively adapted to execute and store instructions, including instructions organized into:
a receiver to:
receive a first input from a user indicating an examination type;
receive a video stream of a patient from a sensing device; and
receive a data stream associated with the patient from the sensing device;
a converter to:
determine a joint location associated with the examination type;
determine a range of motion angle for the determined joint location based on the received data stream; and
store the determined range of motion angle in a datastore; and
a video controller to:
generate a geometric shape overlay;
superimpose the geometric shape overlay onto the received video stream of the patient; and
send the video stream with the superimposed geometric shape overlay and the calculated range of motion angle to a display device.

13. The computing device of claim 12, wherein the instructions are further organized into:
the converter to:
retrieve from the datastore, at least one previously determined range of motion angle associated with the determined joint location of the patient; and
the video controller to:
present the determined range of motion angle and the retrieved previously determined range of motion angle in a form of at least one of a table, graph, and chart.

14. The computing device of claim 12, wherein the instructions are further organized into:
the converter to:
determine an orientation of the patient with respect to the sensing device;
compare the determined orientation to a reference orientation; and
provide an indication for orientation adjustment.

15. The computing device of claim 12, wherein the received data stream of the patient includes locations of a plurality of joints, and
wherein the instruction to determine the range of motion angle for the determined joint location comprises instructions to:
determine a subset of the joint locations based on the examination type indication;
determine a first vector and a second vector from at least two of the determined subset of joint locations; and
calculate the range of motion angle between the first vector and the second vector.

16. The computing device of claim 12, wherein the determined joint location is the patient's knee location, and
wherein the instruction to determine the range of motion angle for the knee location comprises instructions to:
apply a radius filter centered on the knee location to obtain an area of interest;
estimate a first line in the area of interest that approximates a lower leg of the patient;
estimate a second line in the area of interest that approximates an upper leg of the patient; and
determine the range of motion angle based on the angle formed by the first line and the second line.

17. The computing device of claim 12, wherein the instructions are further organized into:
a modeler to:
create an avatar that performs desired movements;
the video controller to:
transmit the avatar, the video stream with the superimposed geometric shape overlay, and the determined range of motion angle to the display device;
cause the transmitted avatar to be displayed in a first region of the display device;
cause the video stream with the superimposed geometric shape overlay to be displayed in a second region of the display device; and
cause the determined range of motion angle to be displayed in a third region of the display device.

18. The computing device of claim 12, wherein the geometric shape overlay includes at least two circle overlays and one line overlay; and
wherein the instructions to superimpose the geometric shape further comprises instructions to:
superimpose the two circle overlays over two joint locations; and
superimpose the line overlay between the two joint locations.

19. A computer-readable storage medium having instructions stored therein for performing a process for measuring a range of motion of a musculoskeletal joint in a human or animal patient, the process comprising:
receiving, at a computing device, a first input from a user indicating an examination type;
receiving a video stream of a patient from a sensing device;
receiving a data stream associated with the patient from the sensing device;
determining a joint location associated with the examination type;
generating a geometric shape overlay;
superimposing the geometric shape overlay onto the received video stream of the patient;
determining a range of motion angle for the determined joint location based on the received data stream;
sending the video stream with the superimposed geometric shape overlay and the calculated range of motion angle to a display device; and
storing the determined range of motion angle in a datastore.

20. The computer readable storage medium of claim 19, wherein determining the range of motion angle for the determined joint location comprises:
determining a subset of the joint locations based on the examination type indication;
determining a first vector and a second vector from at least two of the determined subset of joint locations; and
calculating the range of motion angle between the first vector and the second vector.
